(19) United States
(12) Patent Application Publication
(10) Pub. No.: US 2008/0078297 A1
(43) Pub. Date: Apr. 3, 2008

(54) PRINTER

(76) Inventors: MASAYUKI SETO, Miyazaki (JP); Naoto Yanagihara, Miyazaki (JP); Mikio Nakashima, Kunitomi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/740,321

(22) Filed: Apr. 26, 2007

(30) Foreign Application Priority Data
Sep. 29, 2006 (JP) JP2006-266803

(51) Int. Cl. B41L 13/18

(52) U.S. Cl. 101/123

(57) ABSTRACT

The invention provides a technique which can improve a printing precision of a screen printing. A fixing mechanism for fixing a screen mask of a printer to a mask holder is structured such as to include a first fixing mechanism fixing sides of four sides of a frame existing in an outer peripheral edge of the screen mask arranged along an arrow corresponding to a sliding direction of a squeegee, and the mask holder, and a second fixing mechanism fixing a side of four sides of the frame arranged along a direction intersecting the arrow and in an opposite direction to the arrow as seen from the slide starting position, and the mask holder.

### CROSS-REFERENCE TO RELATED APPLICATION

The present application claims priority from Japanese Patent Application No. JP 2006-266803 filed on Sep. 29, 2006, the content of which is hereby incorporated by reference into this application.

### TECHNICAL FIELD OF THE INVENTION

The present invention relates to a printing technique, and more particularly to a technique effectively applied to a screen printing.

### BACKGROUND OF THE INVENTION

In Japanese Patent Laid-Open Publication No. 2000-202987 (Patent Document 1), the following structure is described as a light frame for a screen printing in which a deformation amount caused by a tensile force of a screen is reduced. An opening portion in an axial direction is formed in an inner corner portion of a screen printing frame which is constituted by a rectangular pipe made of an aluminum alloy and is assembled in a quadrilateral shape and to which a printing screen is attached in a state in which a tensile force is applied, and a carbon fiber bundle is inserted in a state in which the tensile force is applied thereto.

This structure is supported to improve a rigidity against a bending stress of the frame, and suppress an increase of a gravitational force.

### SUMMARY OF THE INVENTION

The screen printing is one of stencil printing methods of transcribing a desired pattern on a printed subject by putting a printing agent such as an ink or the like through a stencil screen with squeezing (extrusion of the printing agent by a squeegee) and is utilized in various intended uses such as a formation of a circuit wiring on an IC board, a formation of an electrode of a flat display panel such as a plasma display panel (PDP) or the like, a formation of a fluorescent material layer and the like.

Particularly, the screen printing technique is applied to an electrode forming step, a fluorescent material layer forming step and the like in a manufacturing step of the PDP. In recent years, to enlarge a display surface size of a display or make a display image high definition, a technique of executing a high-precision printing using a large-sized screen mask is required.

The inventors of the present invention have made a study of the technique of executing a high-precision printing by the screen mask, and have found the following challenge.

In order to execute the high-precision screen printing, it is necessary to arrange the screen mask and the printed subject such as the substrate or the like in a predetermined positional relation, and execute the squeezing with maintaining the predetermined positional relation at a high precision, and transcribe to the printed subject.

Note that, since the screen printing puts the printing agent through the screen mask with squeezing so as to transcribe to the printed subject, a part of the printing agent adheres to a back surface of the screen mask by executing the squeezing (generally called as a back circulation).

The back-circulated printing agent is wiped out by a cleaning apparatus (generally called as a back wiping), however, since the back wiping step can not be executed at a printing execution position, the back wiping step is executed by transferring the screen mask to a cleaning execution position from a printing execution position (transferring the screen mask together with a mask holder in a state in which a mask frame of the screen mask is fixed to the mask holder). The back-wiped screen mask is again transferred to the printing execution position, and the next printing is executed.

Since the back wiping is executed every one or several times of the squeezing, the screen mask is transferred between the cleaning execution position and the printing execution position in each time.

Here, in the step of transferring the screen mask to the printing work execution position, there is a case that the mask holder is deformed, for example, due to a strain of a guide rail for transferring or the like. Since the mask frame is fixed to the mask holder, the mask frame is slightly deformed according to the mask holder.

Further, in the squeezing step, the squeegee is slid from one side of a quadrangle of the mask frame toward a direction of an opposite side with being pressed from an upper surface of the screen mask to a direction of a lower surface by a predetermined pressing.

Here, since a bending stress is applied to the mask frame along a sliding direction of the squeegee, there is a case that the mask frame (particularly, a position corresponding to a printing effective region) is slightly deformed. Since a rigidity of the mask frame becomes smaller in accordance with an enlargement of a plane dimension of the screen mask, an amount of deformation of the mask frame in accordance with the squeezing is enlarged in proportion to the plane dimension of the screen mask (particularly, a dimension in a direction intersecting a sliding direction of the squeegee).

As a means for suppressing the deformation of the mask frame, for example, there is a method of reinforcing the mask frame, as described in Patent Document 1.

However, if the suppression of the deformation of the mask frame is performed only in accordance with the method of reinforcing the mask frame, it is necessary to insert a good deal of reinforcing materials to the mask frame. Further, since the rigidity of the mask frame is decreased in accordance with an enlargement of the plane dimension of the screen mask, an inserting amount of the reinforcing material is increased, and a weight of the screen mask is increased.

If the weight of the screen mask is increased, it becomes hard to carry the screen mask at a replacing work of the screen mask or the like. Further, in order to improve a mechanical strength of the printer, there is generated a problem that the apparatus is enlarged.

Since the amount of deformation of the mask frame caused by two factors mentioned above is small, the deformation has not been conventionally recognized. However, in order to obtain a printing precision required for the high definition of the display image of the PDP, the deformation is not negligible.

In other words, in the case of employing only the method of inserting the reinforcing material to the mask frame as a means for improving the printing precision of the screen printing, there is a case that a desired printing precision can not be obtained.

An object of the present invention is to provide a technique which can improve a printing precision of a screen printing. Further, the other object of the present invention is to provide a technique which can make a PDP definition higher.

The object mentioned above and the other objects and novel features of the present invention will be apparent from the description of the present specification and the accompanying drawings.

An outline of typical elements of the invention disclosed in this application is described briefly as follows.

In other words, the present invention is structured such that a fixing mechanism for fixing a screen mask of a printer to a mask holder comprises a first fixing mechanism, fixing a first side and a second side arranged along a sliding direction of a squeegee of four sides of a mask frame existing in an outer peripheral edge of the screen mask and the mask holder, and a second fixing mechanism, fixing a third side arranged along a direction intersecting the sliding direction and in an opposite direction to the sliding direction as seen from the slide starting position in four sides of the mask frame and the mask holder.

An advantageous effect obtained by typical elements of the invention disclosed in this application is described briefly as follows.

In other words, in accordance with the present invention, it is possible to improve a printing precision of the screen printing.

### BRIEF DESCRIPTIONS OF THE DRAWINGS

FIG. 1 is a perspective view showing a state in which a screen mask is mounted on a mask holder of a printer in accordance with an embodiment 1 of the present invention;

FIG. 2 is a perspective view showing a state in which the mask holder having the screen mask shown in FIG. 1 mounted thereon is transferred to a printing execution position;

FIG. 3 is a plan view of the mask holder and the screen mask of the printer shown in FIG. 2 as seen from an upper face;

FIG. 4 is a plan view of the mask holder and the screen mask of the printer shown in FIG. 2 as seen from a lower face;

FIG. 5 is a cross sectional view showing a state of being cut in a direction of a lower face along a line A-A shown in FIG. 3;

FIG. 6 is a cross sectional view showing a state of being cut in the direction of the lower face along a line B-B shown in FIG. 3;

FIG. 7 is a cross sectional view of a main portion showing a step of mounting the screen mask on the mask holder of the printer in accordance with the embodiment 1 of the present invention;

FIG. 8 is a cross sectional view of a main portion showing a step of transferring the screen mask from a position where the screen mask is mounted on the mask holder to a printing execution position of the printer in accordance with the embodiment 1 of the present invention;

FIG. 9 is a cross sectional view of a main portion showing a step of transcribing a printing agent to a printed subject on the basis of an operation of an extruding mechanism of the printer in accordance with the embodiment 1 of the present invention;

FIG. 10 is a cross sectional view of a main portion showing a step of cleaning a back surface of the screen mask of the printer in accordance with the embodiment 1 of the present invention;

FIG. 11 is a perspective view of a printer in accordance with an embodiment 2 of the present invention;

FIG. 12 is a plan view of a squeegee, a mask holder and a screen mask of the printer shown in FIG. 11 as seen from an upper face;

FIG. 13 is a cross sectional view showing a state of being cut in a direction of a lower face along a line B-B shown in FIG. 12;

FIG. 14 is a cross sectional view showing a state of being cut in the direction of the lower face along a line C-C shown in FIG. 12;

FIG. 15 is a plan view showing a state after transferring a screen mask fixed to a mask holder of a printer in accordance with a comparative example of the embodiment 1 of the present invention to a printing execution position; and

FIG. 16 is a plan view showing a deformed state of a screen mask at executing a screen printing using a printer provided with no second fixing mechanism in accordance with a comparative example of the embodiment 2 of the present invention.

### DESCRIPTIONS OF THE PREFERRED EMBODIMENTS

In the following embodiments, a description will be given by dividing into a plurality of sections or embodiments as occasion demands as a matter of convenience, however, the elements are not nothing to each other except a particularly clear description, but one is a modified example, details, a supplementary explanation or the like of a part or a whole of the other.

Further, in the following embodiments, in the case of referring to a number of elements (including a number, a numerical value, an amount, a range and the like), the present invention is not limited to the defined number except the case of the particular definition and the case of apparently limited to the specific number in principle, but may be equal to or more than the defined number or equal to or less than the defined number.

In all of the drawings for explaining the present embodiment, the same reference symbols are attached to the elements having the same functions, and a repeated description will be basically omitted. A description of embodiments of the present invention will be given in detail below with reference to the accompanying drawings.

### Embodiment 1

In the embodiment 1, regarding a screen printing technique in accordance with the present invention, an example of a manufacturing step of a PDP in which a fluorescent material layer is formed within a cell comparted by a partition wall (a partition wall for comparting a discharge space per cells) formed on a substrate surface of the PDP is described.

A method of forming the partition wall on the substrate surface of the PDP so as to compart the discharge space per cells is broadly divided into a method of comparting by a band-like partition wall (hereinafter, refer to as a stripe rib), and a method of comparting by a grid-like partition wall (hereinafter, refer to as a box rib).

Heretofore, the method of comparting by the stripe rib is general, however, in order to make a definition of the PDP display higher, a pitch of stripe ribs arrangement becomes short, and a case of employing the method of comparting by the box rib is increasing for the purpose of improving a brightness of the PDP or the like.

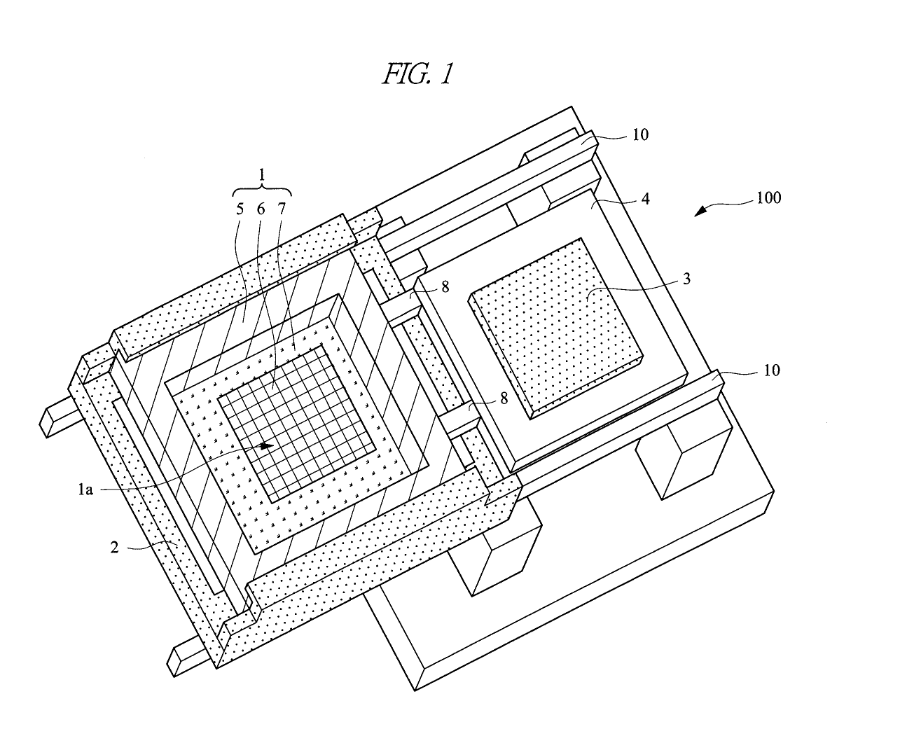

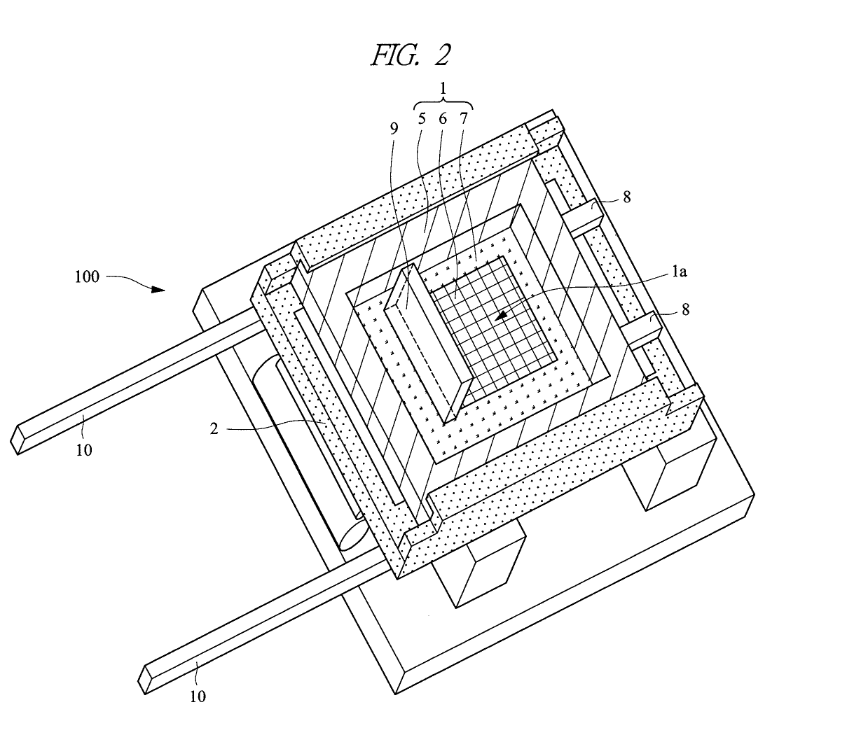

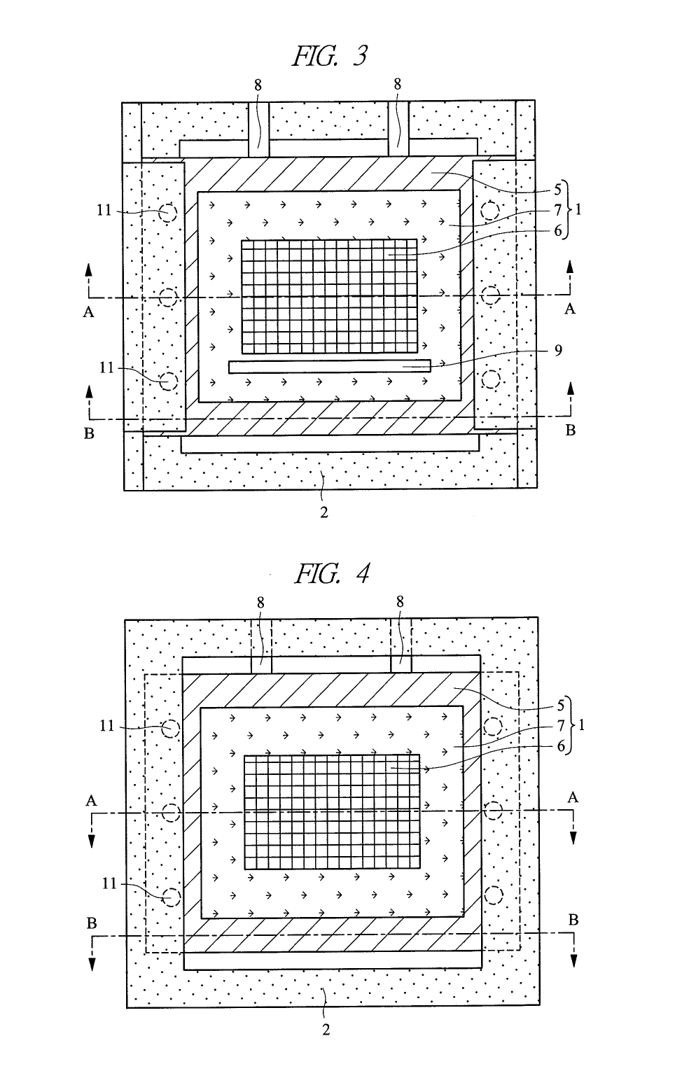

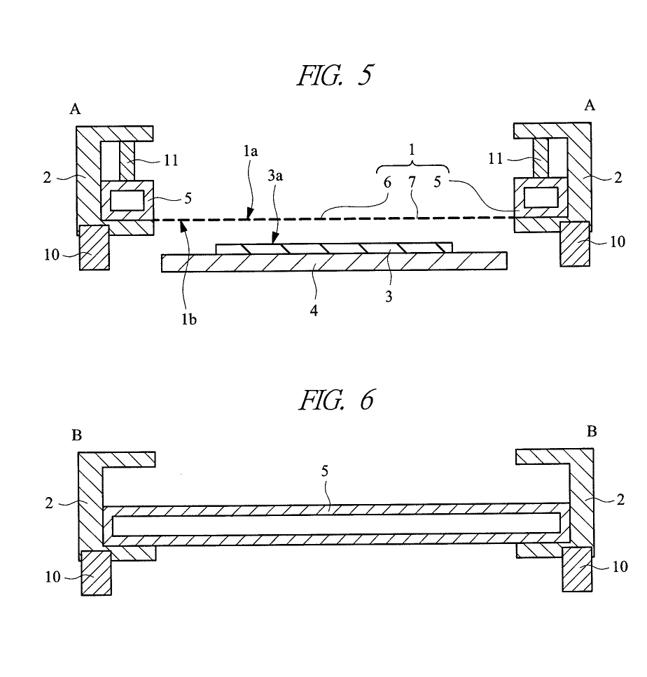

FIG. 1 is a perspective view showing a state in which a screen mask is mounted on a mask holder of a printer in accordance with the present embodiment 1, FIG. 2 is a perspective view showing a state in which the mask holder having the screen mask mounted shown in FIG. 1 thereon is transferred to a printing execution position, FIG. 3 is a plan view of the screen mask and the mask holder shown in FIG. 2 as seen from an upper face, FIG. 4 is a plan view of the screen mask and the mask holder shown in FIG. 2 as seen from a lower face, FIG. 5 is a cross sectional view of a main portion showing a state of being cut in a direction of a lower face along a line A-A shown in FIG. 3, and FIG. 6 is a cross sectional view of a main portion showing a state of being cut in the direction of the lower face along a line B-B.

In FIG. 1, a printer 100 has a screen mask 1, a mask holder 2 holding the screen mask 1, and a printing stage 4 mounting a substrate (a printed subject) 3, for example having a box rib formed on one main surface.

As shown in FIG. 5, the screen mask 1 has an upper main surface (a first main surface) 1a and a lower main surface (a second main surface) 1b positioned in opposite sides to each other, and is provided with a frame 5 (a mask frame) in an outer peripheral edge. Further, the screen mask 1 is provided with an inner lawn 6 in which a hole portion putting a printing agent therethrough in a direction of the lower main surface 1b from the upper main surface 1a is formed in a desired pattern, and an outer lawn 7 tensioning the inner lawn 6 in a direction of the frame 5.

Further, the upper main surface 1a of the screen mask 1 is firmly attached to a lower surface of the frame 5 by an adhesive agent or the like in a facing state, and the inner lawn 6 and the outer lawn 7 are held in a state of maintaining a desired tensioned state. Further, the frame 5 is structured, as shown in FIGS. 4 and 5, such that a rectangular pipe is formed in a quadrangular shape, and is constituted by a metal material, for example, an aluminum alloy or the like.

And, a reinforcing material is inserted to an inner portion of the frame 5 in correspondence to a magnitude of a plane dimension (a dimension as seen from the main surface 1a side) of the screen mask.

As shown in FIG. 1, the screen mask 1 is inserted to a C-shaped guide portion of the mask holder 2 in a state of being sandwiched by the guide portion. A position of the screen mask 1 in an inserting direction is determined by a stopper 8 formed in one side of the mask holder 2, and the screen mask 1 is mounted to the mask holder 2.

Further, as shown in FIG. 2, the printer 100 includes a squeegee 9, and the squeegee 9 has an extruding mechanism sliding the upper main surface 1a of the screen mask 1 in a direction of the substrate 3 at executing of printing and extruding a fluorescent material paste (not shown), which is a printing agent, to the lower main surface 1b side.

Further, as shown in FIGS. 1 and 2, the printer 100 includes a transfer mechanism transferring the screen mask 1 from a position (a first position) where the screen mask 1 is mounted to the mask holder 2, to a position where the fluorescent material paste filled in a cell defined by the box rib formed in the main surface of the substrate 3, that is, a printing execution position (a second position), in a state in which the screen mask 1 is mounted to the mask holder 2.

Here, the printing execution position corresponds to a position where the fluorescent material paste corresponding to the printing agent is made to go through the hole portion formed in the inner lawn 6 in the direction of the main surface 1b from the main surface 1a by the sliding motion of the squeegee 9 so as to fill (that is, transfer) within the cell defined by the rib. At the printing execution position, the screen mask 1 and the substrate 3 have a predetermined positional relation required for the filling.

As the transfer mechanism, as shown in FIGS. 1 and 2, there is exemplified a method of transferring the mask holder 2 supporting the screen mask 1 along the guide rail 10. As a power for the transfer, for example, an electric motor or the like can be employed.

In a step of transferring to the printing execution position from the first position, the frame 5 of the screen mask 1 is in a state of being supported by the mask holder 2, and the screen mask 1 is not fixed to the mask holder 2.

The screen mask 1 transferred to the printing execution position together with the mask holder 2 is fixed by a clamp 11 shown in FIGS. 3 to 5 (a first fixing mechanism). The clamp 11 is constituted by a rod-like member, for example, an air cylinder or the like, and is fixed by pressing the frame 5 in a direction of a member in a lower side from a member in an upper side of the mask holder 2.

Note that, the first fixing mechanism may be structured by every means as far as it is possible to suppress a phenomenon that the frame 5 is moved by a force generated at the printing (that is, a force applied in a sliding direction on the basis of the sliding motion of the squeegee 9 while pressing) within an allowable range, and is not limited to the method mentioned above.

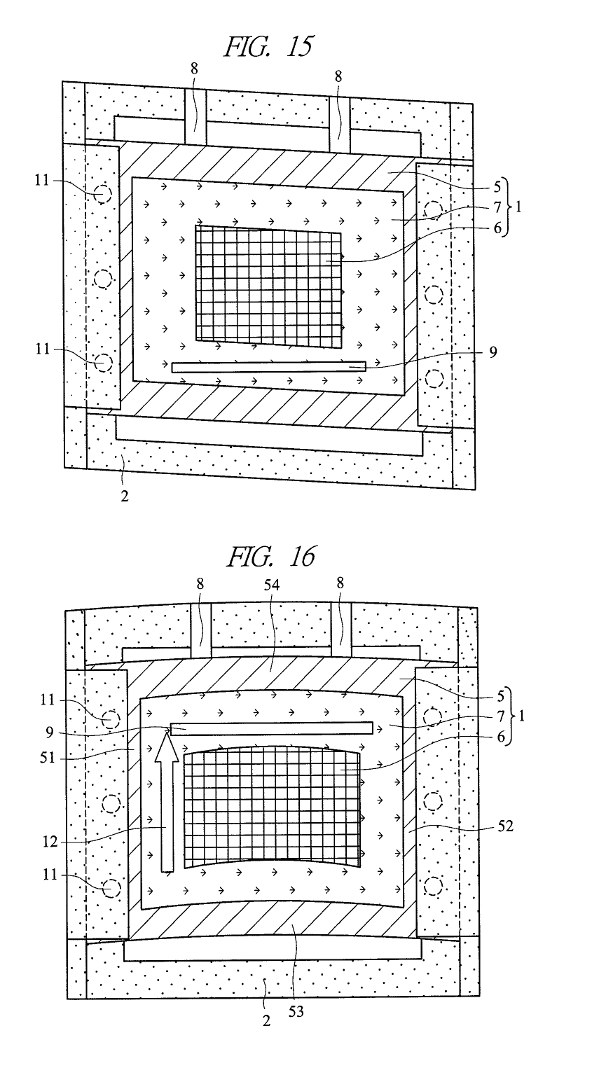

In the present embodiment 1, the fixation by the clamp 11, that is, the first fixing mechanism operates at the printing execution position. A description will be given of a problem in the case that the first fixing mechanism is actuated at the other positions than the printing execution position with reference to FIG. 15.

FIG. 15 is a plan view showing a state after transferring the screen mask fixed to the mask holder of the printer in accordance with a comparative example of the present embodiment 1 to the printing execution position. In FIG. 15, reference symbols shown in FIG. 15 correspond to reference symbols shown in FIG. 3 in accordance with the present embodiment 1. Further, FIG. 15 shows a deformation of the screen mask exaggeratingly for easily understanding a deformation state of the screen mask.

If a strain exists in the guide rail 10 at the step of transferring the screen mask 1 from the position mounting the screen mask 1 to the mask holder 2 to the printing execution position, there is a case that the mask holder 2 is deformed as shown in FIG. 15. At this time, in the case that the frame 5 of the screen mask 1 is fixed to the mask holder, the mask frame is slightly deformed according to the mask holder.

Since the inner lawn 6 corresponding to the printing effective region of the screen mask 1 is tensioned by the outer lawn 6 on the basis of a tension within a fixed range in the direction of the frame 5, the inner lawn 6 is deformed according to the deformation of the frame 5. Therefore, in the comparative example of the present embodiment 1, there is a case that a printing precision is deviated from the allowable range.

If the printing precision is deviated from the allowable range, each of the fluorescent material pasts of red, green and blue (RGB) is not filled within the predetermined cell, but is filled, for example, in the adjacent cell, as a result, a color mixture failure is generated. And, even if the color mixture failure is not generated, if the fluorescent material runs on a top portion of the rib, there is generated a problem such as a surface irregularity or the like in view of a display of a completed plasma display.

Since the printer in accordance with the present embodiment 1 shown in FIGS. 1 to 6 operates the first fixing mechanism at the printing execution position, the screen mask 1 is not fixed to the mask holder 2 at the transfer of the screen mask 1 from the position mounting the screen mask 1 to the mask holder 2 to the printing execution position, but is mounted in a slidable state.

Accordingly, even if the mask holder 2 is deformed for the reason that the strain is generated in the guide rail 10, for example, shown in FIGS. 1 and 2, it is possible to prevent the frame 5 of the screen mask 1 from being deformed.

In other words, by actuating the first fixing mechanism at the printing execution position, the printer in accordance with the present embodiment 1 can prevent the frame 5 from being deformed at the transfer of the screen mask 1 from the position mounting the screen mask 1 to the mask holder 2 to the printing execution position, as a result, it is possible to improve a printing precision.

Here, a description of a method of applying a screen printing to the printed subject by using the printer 100 in accordance with the present embodiment 1 will be given by exemplifying a method of filling each of the fluorescent material pastes of RGB within each of the cells defined by the rib formed in the substrate 3.

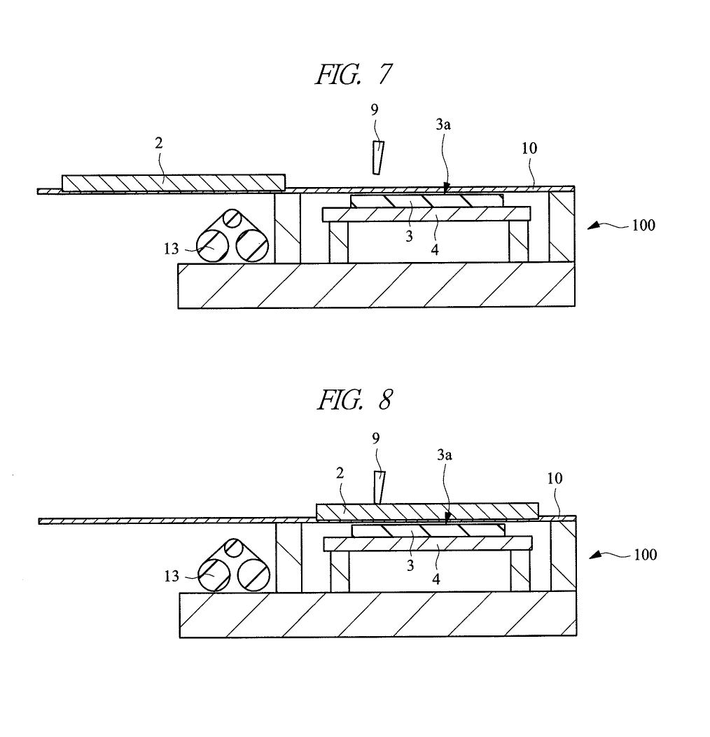

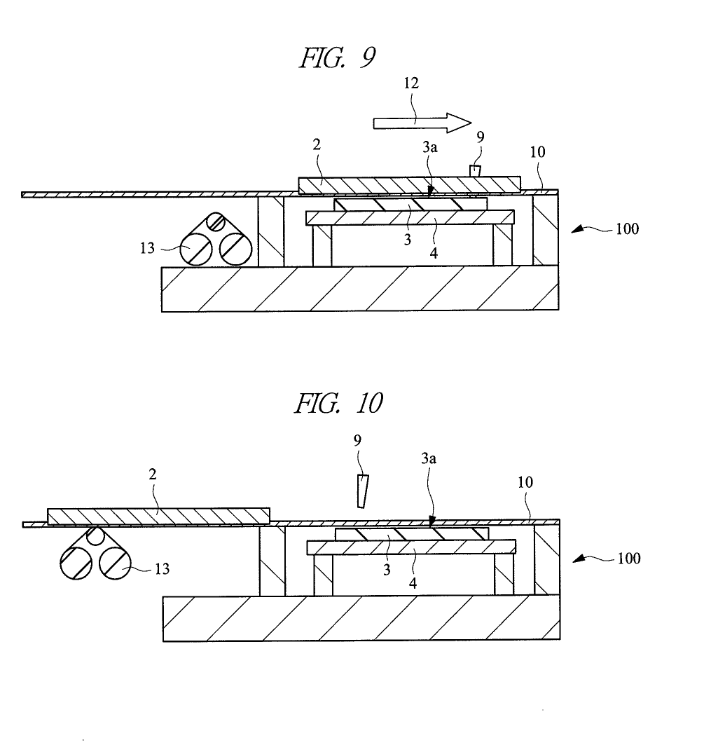

FIG. 7 is a cross sectional view of a main portion showing a step of mounting the screen mask on the mask holder of the printer in accordance with the present embodiment 1, FIG. 8 is a cross sectional view of a main portion showing a step of transferring the screen mask from the position mounting the screen mask on the mask holder of the printer in accordance with the present embodiment 1 to the printing execution position, FIG. 9 is a cross sectional view of a main portion showing a step of transcribing the printing agent to the printed subject on the basis of an operation of the extruding mechanism of the printer in accordance with the present embodiment 1, and FIG. 10 is a cross sectional view of a main portion showing a step of cleaning a back surface of the screen mask of the printer in accordance with the present embodiment 1.

(a) First, as shown in FIG. 7, the screen mask 1 is mounted to the mask holder 2 at a first position. In this step, the frame 5 of the screen mask 1 is in a state of being supported by the mask holder 2, and the screen mask 1 is not fixed to the mask holder 2.

Further, the substrate 3 is mounted on the printing stage 4.

(b) Next, as shown in FIG. 8, the mask holder 2 is transferred to the printing execution position (a second position) in a state of supporting the frame 5 of the screen mask 1. As a transferring means, as already described, a method of transferring the mask holder 2 along the guide rail 10 can be exemplified.

(c) After the screen mask 1 and the mask holder 2 are transferred to the printing execution position, the first fixing mechanism of the printer 100 is actuated, and the screen mask 1 is fixed to the mask holder 2. As the first fixing mechanism, as already described with reference to FIGS. 3 to 5, a method of pressing the frame 5 in the direction of the member in the lower side from the member in the upper side of the mask holder 2 so as to fix, for example, by means of the clamp 11 can be exemplified.

In accordance with the printing method of the present embodiment 1, by actuating the first fixing mechanism at the transfer of the first fixing mechanism to the printing execution position, it is possible to prevent the frame 5 from being deformed at the transfer of the screen mask 1 to the printing execution position from the position mounting the screen mask 1 to the mask holder 2, as a result, a printing precision can be improved.

(d) After the screen mask 1 is fixed to the mask holder 2 at the printing execution position, the substrate 3 is transferred so as to be arranged at the printing execution position. The substrate 3 is adjusted at the predetermined printing position on the basis of the movement of the printing stage 4 in a state in which the substrate 3 is mounted.

As a tangible means for adjusting the position, a method of recognizing the positions of the screen mask 1 and the substrate 3 by an infrared ray sensor or the like and moving the printing stage 4 so as to achieve a predetermined positional relation can be exemplified.

The printing stage 4 in accordance with the present embodiment 1 is supported by the frame of the printer 100 in a state in which the printing stage 4 can move in a direction along the main surface 1b of the screen mask 1, and a direction intersecting the main surface 1b. Therefore, it is possible to transfer the substrate 3 to the printing execution position by moving the printing stage 4 in a state in which the substrate 3 is mounted.

(e) After each of the screen mask 1 and the substrate 3 is arranged at the printing execution position, the squeezing mechanism (the extruding mechanism) of the printer 100 is actuated, and the fluorescent material paste as the printing agent is transcribed to the substrate 3 as the printed subject. In other words, a first transcribing step is executed.

Here, a box rib or a stripe rib is formed on a main surface 3a of the substrate 3 facing to the main surface 1b shown in FIG. 9. The squeegee 9 slides in a direction shown by an arrow 12 in the drawing (a sliding direction) with pressing the inner lawn 6 (refer to FIG. 3) of the screen mask 1 in a direction of the main surface 3a of the substrate 3 from the main surface 1a, thereby filling (that is, transcribing) the fluorescent material paste, for example, the red fluorescent material paste within the cell defined by the rib formed on the main surface 3a of the substrate 3.

Since the inner lawn 6 of the screen mask 1 is tensioned in the direction of the frame 5 by a tensile force within a predetermined range, the inner lawn 6 and the substrate 3 are disconnected in a state of finishing the sliding motion of the squeegee 9 so as to move to an upper portion, and the first transcribing step is finished.

(f) Since the transcribing step the fluorescent material paste is put through the hole portion of the inner lawn 6 in accordance with the squeezing so as to be fill in the substrate 3, a part of the fluorescent material paste adheres to a back surface of the screen mask 1 by executing the squeezing (a back circulation).

In the case of filling the different kinds of fluorescent material pastes, it is necessary to wipe out the adhered fluorescent material paste for preventing a problem of a color mixture. Therefore, the fluorescent material paste adhered to the main surface 1b of the screen mask 1 is cleaned by a cleaning apparatus 13, as shown in FIG. 10.

Prior to a cleaning step, it is necessary to transfer the screen mask 1 to a cleaning execution position (a first position) in order to secure a space for arranging the cleaning apparatus 13. As a means for transferring, a method of transferring to the cleaning execution position after canceling the first fixing mechanism can be considered also.

However, if the first fixing mechanism is cancelled, it is necessary to recognize the positions of the screen mask 1 and the substrate 3 again in a second transcribing step executed after the cleaning, therefore, the work becomes complicated. In order to avoid the position recognition prior to the second transcribing step, it is necessary to transfer the screen mask 1 in a state of being fixed to the mask holder 2.

Here, in the case of transferring the screen mask 1 with fixed to the mask holder 2, there is a case that the mask holder 2 and the mask frame 5 are slightly deformed if the strain exists in the guide rail 10, as already described.

As a result of a study of the inventors of the present invention, there has been found that the mask frame 5 is restored to a shape at actuation of the first fixing mechanism even in this case, by executing the cleaning step and the transferring step to the printing execution position with the state of the screen mask 1 fixed to the mask holder 2 maintained.

In other words, according to the present embodiment 1, since the mask frame 5 can be restored at the printing execution position by actuating the first fixing mechanism at the printing execution position, even if the mask frame 5 is deformed at the transferring step, a printing precision of the printer according to the embodiment 1 can be improved.

Note that, in the present embodiment 1, the position mounting the screen mask 1 to the mask holder 2, and the cleaning execution position are distinctively described for convenience of explanation, however, these positions can be the same position. If they are set to the same position, a proprietary area of the printer can be smaller.

(g) After the cleaning step is finished, the mask holder 2 is transferred to the printing execution position (the second position) as shown in FIG. 8. As already described, the screen mask 1 is transferred in a state of being fixed to the mask holder 2 at this time.

The steps described in the items (d) to (f) mentioned above are repeated thereafter, each of the fluorescent material pastes of RGB is filled at the predetermined position within each of the cells defined by the rib formed in the substrate 3, when the second transcribing step and the third transcribing step are finished.

Note that, the work of recognizing the positions of the screen mask 1 and the substrate 3 in the (d) position adjusting step after the finish of first printing step mentioned above can be omitted.

### Embodiment 2

In the embodiment 1 mentioned above, the description is given by setting the mechanism for fixing the mask frame of the screen mask to the mask holder as the first fixing mechanism, a second fixing mechanism which is different from the first fixing mechanism can be added. In the present embodiment 2, a printer provided with the second fixing mechanism in addition to the first fixing mechanism is described.

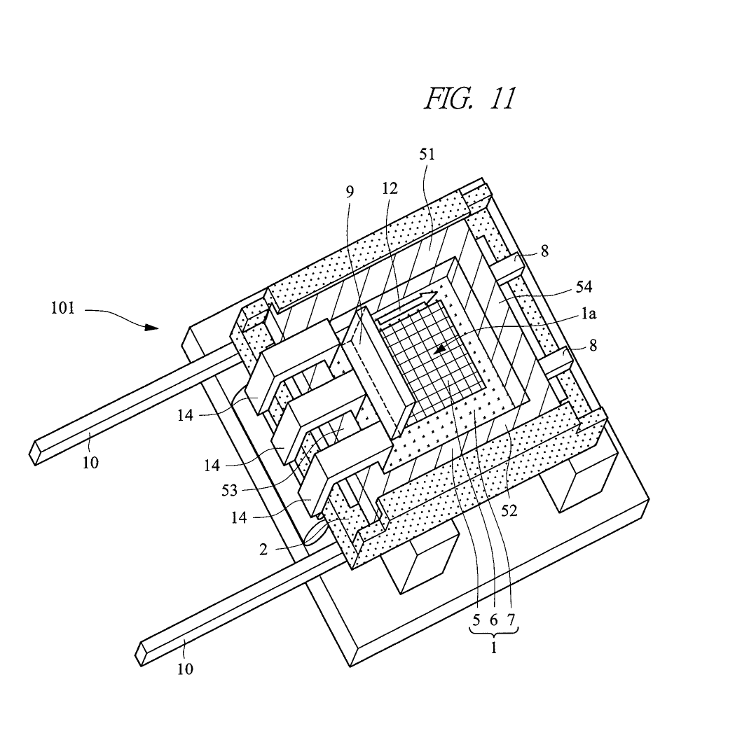

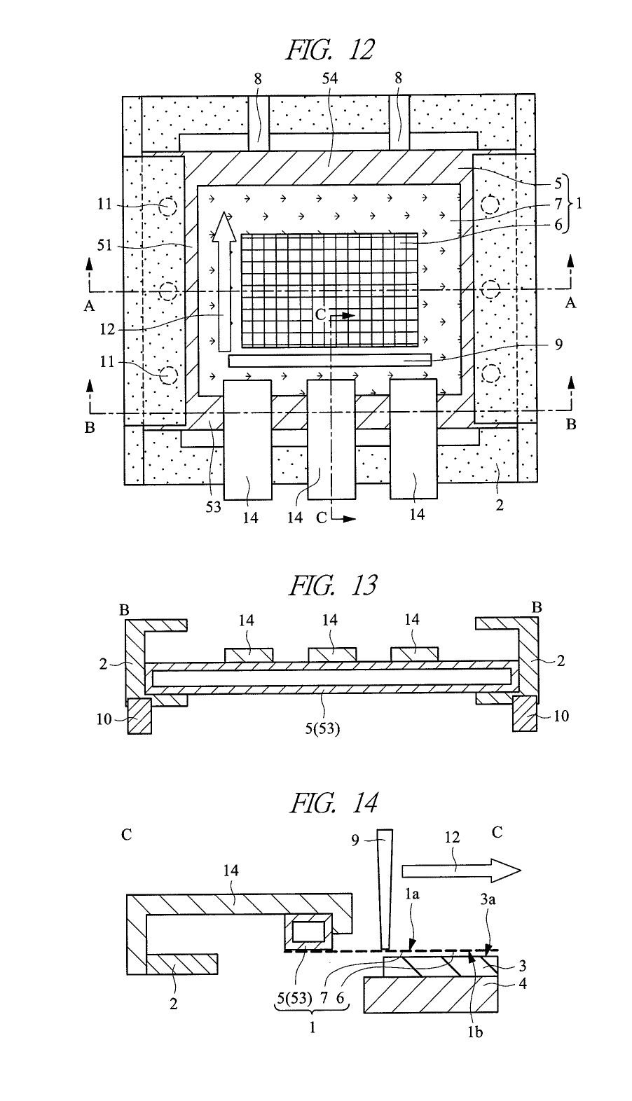

FIG. 11 is a perspective view of a printer according to the embodiment 2, FIG. 12 is a plan view of a squeegee, a screen mask and a mask holder shown in FIG. 11 as seen from an upper face, FIG. 13 is a cross sectional view of a main portion showing a state of being cut in a direction of a lower face along a line B-B shown in FIG. 12, and FIG. 14 is an enlarged cross sectional view of a main portion showing a state of being cut in the direction of the lower face along a line C-C. Here, the cross sectional view along a line A-A shown in FIG. 12 has the same structure as the cross sectional view shown in FIG. 5, therefore, an illustration will be omitted.

A different point between a printer 101 according to the present embodiment 2 shown in FIG. 11 and the printer 100 according to the embodiment 1 shown in FIG. 2 is that the printer 101 includes a fixing jig (a second fixing mechanism) 14.

In FIG. 11, the printer 101 comprises a screen mask 1, and a mask holder 2 supporting a mask frame 5 of the screen mask. Although not illustrated in FIG. 11 because FIG. 11 shows a state after transfer of the mask holder 2 to a printing execution position, the printer 101 includes a printing stage 4 (refer to FIGS. 5 and 14) on which a substrate 3 (refer to FIGS. 5 and 14) as a printed subject is mounted, in a lower side of the screen mask 1.

Further, the screen mask 1 has an upper main surface (a first main surface) 1a and a lower main surface (a second main surface) 1b (refer to FIGS. 5 and 14), and is provided with the frame (the mask frame) 5 having four sides 51, 52, 53 and 54 in an outer peripheral edge.

And, the printer 101 comprises a squeegee 9, and the squeegee 9 has a mechanism (an extruding mechanism) sliding in a direction shown by an arrow 12 (a first direction) 12 in FIG. 11 while pressing the main surface 1a of the screen mask 1 in a direction of the substrate 3 in a transferring step and extruding a printing agent (not shown) to the main surface 1b side.

Further, the printer 101 is provided with a fixing mechanism for fixing the screen mask 1 to the mask holder 2. Here, a description of the fixing mechanism will be given in detail.

The frame 5 of the screen mask 1 has four sides 51, 52, 53 and 54 as shown in FIG. 11. The side (the first side) 51 and the side (the second side) 52 arranged so as to extend along the direction of the arrow 12 of these four sides are fixed to the mask holder 2 by a clamp 11 (a first fixing mechanism), in the same manner as the printer 100 described in the embodiment 1 mentioned above.

On the other hand, in the printer 101, in the side (the third side) 53 and the side (the fourth side) 54 that are arranged so as to extend along a direction (a second direction) intersecting the direction of the arrow 12, the side (the third side) 53 arranged in an opposite direction to the direction shown by the arrow 12 is fixed to the mask holder 2 by the fixing jig 14 (a second fixing mechanism).

Here, a problem in the case that the screen printing is executed by the printer not including the second fixing mechanism is described with reference to FIG. 16.

FIG. 16 is a plan view showing a deformed state of the screen mask at execution of the screen printing using the printer not including second fixing mechanism according to a comparative example of the present embodiment 2. Reference symbols shown in FIG. 16 correspond to reference symbols shown in FIG. 12 of the present embodiment 2. Further, FIG. 16 shows a deformation of the screen mask exaggeratingly for easily understanding a deformation state of the screen mask.

In FIG. 16, the squeegee 9 is slid toward an end point (a leading end of an arrow 12) in an upper side from a start point in a lower side of the arrow 12, at a transcribing step. At this time, since the squeegee 9 is slid with pressing an inner lawn 6 and an outer lawn 7 in a direction of a printed subject (a direction of a back surface from a front surface of a paper on which FIG. 16 drawn), an external force in a direction along the arrow 12 is applied to the sides 53 and 54 of the frame 5.

As a result of an application of the external force described above, there is a case that the sides 53 and 54 of the frame 5 are deformed as shown in FIG. 16. The deformation of the frame 5 caused by the external force at sliding is particularly large in a portion in which a combination of the frame 5 is weakest, that is, near a center of the sides 53 and 54. If the sides 53 and 54 of the frame 5 are deformed, the inner lawn 6, which is the printing effective region, is deformed according to the deformation.

As already described, in order to execute the screen printing, it is necessary to arrange the screen mask and the printed subject in the predetermined positional relation, and execute the squeezing with the predetermined positional relation precisely maintained so as to transcribe to the printed subject.

Therefore, if the inner lawn 6 which is the printing effective region is deformed, it is impossible to maintain the predetermined positional relation in accordance with this deformation. Further, since the degree of the deformation of the inner lawn 6 is irregularly generated, a problem that it is impossible to improve the printing precision to be equal to or more than the range of the deformation degree occurs.

The printer 101 in according to the present embodiment 2 can prevent or suppress the deformation of the sides 53 and 54 by comprising the second fixing mechanism. Note that, as a result of the study of the inventors, it is possible to prevent or suppress the deformation of the side 54 by fixing the side 53 to the mask holder 2 by means of the second fixing means.

Here, a description of an example that the fluorescent material paste is filled within each of the cells comparted by the stripe rib or the box rib formed in the panel substrate of the PDP will be given further in detail.

In the case of filling the fluorescent material paste within each of the cells comparted by the stripe rib, since the squeegee is slid along the direction in which the stripe rib is arranged in the band shape, it is preferable to control the positional relation in the direction (the second direction) intersecting the arrow 12 shown in FIG. 12 particularly at a high precision, and the precision of the positional relation in the direction (the first direction) along the arrow 12 is not required as strictly as the second direction.

On the other hand, in the case of filling the fluorescent material paste within each of the cells comparted by the box rib, it is necessary to maintain the predetermined positional relation in the first direction mentioned above at a high precision in the same level as that in the second direction.

Since the printer 101 according to the embodiment 2 can prevent or suppress the inner lawn 6 which is the printing region from being deformed in the direction along the arrow 12, that is, the first direction, it is possible to make the PDP in which the box rib is formed on one main surface particularly higher definition.

In the present embodiment 2, the description of the second fixing mechanism on the basis of the example in which three positions of the side 53 are fixed to the mask holder 2 by three fixing jigs 14 is given, however, the positions fixing the side 53 are not limited to three positions. Since it is sufficient to prevent the deformation of the inner lawn 6 which is the printing effective region or suppress the deformation within the desired range, it is sufficient to fix at least one position of the region facing to the inner lawn 6 corresponding to the printing effective region of the screen mask 1, in the side 53.

As already described, since the deformation of the side 53 becomes largest in the center of the side 53, it is preferable that the fixing position includes at least the center of the side 53. By including the center of the side 53 in the fixing position, it become possible to prevent or suppress the deformation of the inner lawn 6 more securely, it is possible to improve a printing precision.

And, in the present embodiment 2, the example in which the shape of the fixing jig 14 is formed in the C-shaped form is described, however, the shape of the fixing jig 14 is not limited to the C-shaped form as far as it is possible to prevent the deformation of the side 53 of the frame 5 or suppress the deformation within the desired range.

As already described, since the deformation of the side 53 is generated in the direction along the arrow 12 (the first direction), it is preferable that the fixing jig 14 is structured such as to have a surface suppressing a side surface in the first direction side of the side 53 in an opposite direction to the first direction (that is, an outer peripheral direction of the side 53). By forming the structure mentioned above, it becomes possible to prevent or suppress the deformation of the side 53 directly, as a result, the printing precision can be improved.

Further, in the present embodiment 2, the positions actuating the first fixing mechanism and the second fixing mechanism are not particularly limited. However, it goes without saying that the first fixing mechanism and the second fixing mechanism may be actuated at the printing execution position.

In the printer 101 according to the present embodiment 2, it becomes possible to further improve the printing precision by actuating the first fixing mechanism and the second fixing mechanism at the printing execution position, that is, the position of putting the printing agent through the hole portion formed in the inner lawn 6 in the direction of the main surface 1b from the main surface 1a of the screen mask 1 in accordance with the sliding motion of the squeegee 9 so as to transcribe the printing agent to the printed material.

As a result of a study of the inventors, if the first fixing mechanism and the second fixing mechanism are actuated at the printing execution position in the printer 101 according to the present embodiment 2, it is possible to suppress an amount of displacement of the center portion of the side 53 of the mask frame 5 (a distance at which the center portion of the side 53 moves along the first direction) generated at a the transcribing step within 10 μm.

Here, if the display surface of the plasma display is enlarged, it is necessary to improve a definition of the display surface of the PDP.

Particularly, in the display having a size of 42 inch (a scale indicating a magnitude of the display surface of the display device and indicating a length of a diagonal side of the display surface by inch) and a full high definition (a full HD) or more, a technique of making the definition equal to or less than 180 μm×420 μm is desired.

In order to make the definition equal to or less than 180 μm×420 μm, it is necessary to set the plan dimension of the cell comparted by the box rib to 70 μm×320 μm.

Here, for example, in the case that the fixing jig 14 is not provided in a printer using a screen mask having an outer diameter of 3.5 m×3.3 m, a maximum displacement of the plate frame in the squeezing direction comes to about 120 μm, and if the fluorescent material paste is filled in the cell having the plane dimension of 70 μm×320 μm, the fluorescent material paste is filled also to the adjacent cell.

Further, even if the fixing jig 14 is provided, in the case that the region facing to the printing effective region is not fixed at all in the side 53 of the mask frame, the maximum displacement of the plate frame in the squeezing direction comes to about 50 μm.

In the printer according to the present embodiment, since the region facing to the printing effective region is fixed at one position in the side 53 of the mask frame, it is possible to make the maximum displacement of the plate frame in the squeezing direction equal to or less than 10 μm.

By making the maximum displacement of the plate frame in the squeezing direction equal to or less than 10 μm, it becomes possible to make the maximum displacement of the printing effective region equal to or less than 10 μm. Therefore, it becomes possible to fill the fluorescent agent in the cell having the plane dimension of 70 μm×320 μm without generating a color mixture and a color shade, that is, it is possible to improve the definition of the PDP.

Since the printer 101 according to the present embodiment 2 can improve the printing precision by suppressing the displacement of the center portion of the side 53 at the actuation of the squeegee 9 of the mask frame 5 within 10 μm, it becomes possible to make the PDP definition higher.

In the manufacturing step of the PDP, the screen printing technique is applied to a formation of an address electrode, for example, formed on the back surface of the stripe rib or the box rib, and the like, in addition to the fluorescent material layer forming step (the fluorescent material paste filling step) described in the embodiment 1 mentioned above and the present embodiment 2.

The definition of the PDP is determined on the basis of the definition of each of the cells comparted by the rib. Therefore, if the printing precision of the screen printing is improved, it is possible to make the PDP definition higher.

The description is specifically given of the invention made by the inventors of the present invention on the basis of the embodiments, however, the present invention is not limited to the embodiments of the invention, but can be variously modified within the scope of the invention.

The present invention can be applied to the screen printer, particularly the screen printer in which a high printing precision is required.

What is claimed is:

1. A printer comprising:
a screen mask including a first main surface and a second main surface, and including a mask frame in outer peripheral edge;
a mask holder supporting the mask frame of the screen mask;
a printing stage on which a printed subject is mounted;
an extruding mechanism sliding the first main surface of the screen mask with pressing the first main surface in direction of the printed subject, and extruding a printing agent to the second main surface side;
a transferring mechanism transferring the mask holder from a first position to a second position corresponding to a printing execution position with supporting the mask frame; and
a fixing mechanism fixing the screen mask to the mask holder,
wherein the fixing mechanism is actuated at the second position.

2. A printer comprising:
a screen mask including a first main surface and a second main surface, and including a mask frame having four sides in an outer peripheral edge;
a mask holder supporting the mask frame of the screen mask;
a printing stage on which a printed subject is mounted;
an extruding mechanism sliding the first main surface of the screen mask in a first direction with pressing the first main surface in a direction of the printed subject, and extruding a printing agent to the second main surface side; and
a fixing mechanism fixing the screen mask to the mask holder,
wherein the fixing mechanism comprises:
a first fixing mechanism fixing a first side and a second side of the four sides of the mask frame arranged along the first direction, and the mask holder; and
a second fixing mechanism fixing a third side of the four sides of the mask frame arranged along a second direction intersecting the first direction and in an opposite direction to the first direction as seen from a position at which the extruding mechanism starts the sliding motion, and the mask holder,
wherein the second fixing mechanism fixes at least one position of the third side, in a region facing to the printing effective region of the screen mask.

3. A printer comprising:
a screen mask including a first main surface and a second main surface, and including a mask frame having four sides in an outer peripheral edge;
a mask holder supporting the mask frame of the screen mask;
a printing stage on which a printed subject mounted;
an extruding mechanism sliding the first main surface of the screen mask in a first direction with pressing the first main surface in a direction of the printed subject, and extruding a printing agent to the second main surface side; and
a fixing mechanism fixing the screen mask to the mask holder,
wherein the mask frame comprises:
a first side and a second side arranged along the first direction; and
a third side arranged along a second direction intersecting the first direction and in an opposite direction to the first direction as seen from a position at which the extruding mechanism starts the sliding motion,
wherein a displacement at center portion of the third side deformed along the first direction at actuation of the extruding mechanism is within 10 μm.
